(19) United States
(12) Patent Application Publication
(10) Pub. No.: US 2023/0076165 A1
(43) Pub. Date: Mar. 9, 2023

(54) BASE STATION AND CONTROL METHOD OF BASE STATION

(71) Applicant: KYOCERA CORPORATION, Kyoto (JP)

(72) Inventor: Makoto TOMIZU, Yokohama-shi (JP)

(73) Assignee: KYOCERA CORPORATION, Kyoto (JP)

(21) Appl. No.: 18/056,449

(22) Filed: Nov. 17, 2022

(30) Foreign Application Priority Data
May 18, 2020 (JP) 2020-087015

(51) Int. Cl. H04W 74/08

(52) U.S. Cl. CPC H04W 74/0833

(57) ABSTRACT

A base station used in a mobile communication system includes a wireless communicator performing wireless communication with user equipment, and a controller controlling the wireless communicator. The wireless communicator transmits, to the user equipment, a connection instruction of causing the user equipment to connect to another base station. The controller determines whether to include, in the connection instruction, a random access preamble acquired by the base station from the other base station, based on at least one selected from the group consisting of a congestion level of the other base station and a service type used by the user equipment.

### RELATED APPLICATIONS

The present application is a continuation based on PCT Application No. PCT/JP2021/018680, filed on May 17, 2021, which claims the benefit of Japanese Patent Application No. 2020-087015 filed on May 18, 2020. The content of which is incorporated by reference herein in their entirety.

### TECHNICAL FIELD

The present invention relates to a base station used in a mobile communication system and a control method of the base station.

### BACKGROUND OF INVENTION

In recent years, a fifth generation mobile communication system (hereinafter referred to as a “5G system”) has been attracting attention. The 5G system has features in its high-speed communications, massive machine type communications, and low latency, as compared to a fourth generation mobile communication system (hereinafter referred to as a “4G system”). At the start of commercial services of the 5G system, the 5G system is operated in a non-standalone (NSA) mode using a network infrastructure of the 4G system.

In a configuration of such an NSA mode, user equipment first connects to a 4G system base station (hereinafter referred to as a “4G base station”), subsequently connects to a 5G system base station (hereinafter referred to as a “5G base station”) as well in accordance with a connection instruction from the 4G base station, and thereby performs high speed data communication with the 5G base station.

Here, methods of acquiring a random access preamble to be used when the user equipment connects to the 5G base station include a first method in which the user equipment acquires the random access preamble from system information broadcast by the 5G base station, and a second method in which the 4G base station provides, to the user equipment, the random access preamble that the 4G base station acquires from the 5G base station.

### CITATION LIST

### Non-Patent Literature

NPL 1: 3GPP Technical Specification “TS 38.300 V16.1.0”, Internet <URL: http://www.3gpp.org/ftp//Specs/archive/38_series/38.300/38300-g10.zip>

### SUMMARY

A base station according to a first aspect is a base station used in a mobile communication system. The base station includes a wireless communicator performing wireless communication with user equipment, and a controller controlling the wireless communicator. The wireless communicator transmits, to the user equipment, a connection instruction of causing the user equipment to connect to another base station. The controller determines whether to include, in the connection instruction, a random access preamble acquired by the base station from the other base station, based on at least one selected from the group consisting of a congestion level of the other base station and a service type used by the user equipment.

A control method of a base station according to a second aspect is a control method of a base station performing communication with another base station and performing communication with user equipment in a mobile communication system. The control method includes determining whether to include a random access preamble acquired by a base station from another base station in a connection instruction of causing user equipment to connect to the other base station, and transmitting the connection instruction to the user equipment. The determining includes the determining based on at least one selected from the group consisting of a congestion level of the other base station and a service type used by the user equipment.

A mobile communication system according to a third aspect includes user equipment, and a base station performing communication with another base station and perform communication with the user equipment. The base station includes a random access preamble acquired from the other base station in a connection instruction of causing the user equipment to connect to the other base station, using at least one selected from the group consisting of a congestion level of the other base station and a service type used by the user equipment, when the base station transmits the connection instruction to the user equipment.

### BRIEF DESCRIPTION OF THE DRAWINGS

FIG. 1 is a diagram illustrating a configuration of a mobile communication system according to an embodiment.

FIG. 2 is a diagram illustrating a configuration of user equipment (UE) according to an embodiment.

FIG. 3 is a diagram illustrating a configuration of a base station according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating a contention based random access procedure.

FIG. 7 is a diagram illustrating a first method of connection control to a 5G base station in an NSA configuration.

FIG. 8 is a diagram illustrating a second method of connection control to the 5G base station in the NSA configuration.

FIG. 9 is a diagram illustrating an operation for properly using a corresponding method of connection control to the 5G base station in the NSA configuration depending on each situation.

### DESCRIPTION OF EMBODIMENTS

In the first method described above, the random access preamble acquired by the user equipment may contend with that of other user equipment, and thus a problem arises that a delay may occur in connection processing between the user equipment and the 5G base station. In particular, when the 5G base station is congested, such a problem becomes prominent.

On the other hand, in the second method described above, the random access preamble acquired by the user equipment does not contend with that of other user equipment; however, a problem arises that this requires time for the 4G base station to acquire the random access preamble from the 5G base station.

In view of this, the present disclosure provides enabling smooth connection processing between user equipment and a base station.

A mobile communication system according to an embodiment will be described with reference to the drawings. In the description of the drawings, the same or similar parts are denoted by the same or similar reference signs.

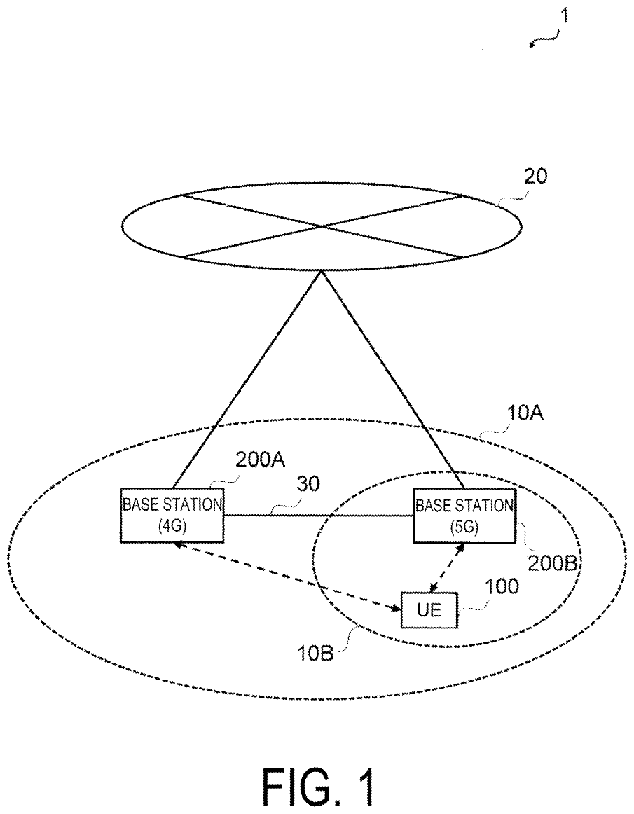

Configuration of Mobile Communication System First, a configuration of a mobile communication system according to an embodiment will be described. FIG. 1 is a diagram illustrating a configuration of a mobile communication system 1 according to an embodiment. In an embodiment, the mobile communication system 1 has an NSA configuration in which the 5G system is operated in an NSA mode.

As illustrated in FIG. 1, the mobile communication system 1 includes user equipment (UE) 100, a 4G base station 200A, a 5G base station 200B, and a core network 20. The 4G base station 200A and the 5G base station 200B are hereinafter referred to as “base station 200” when the 4G base station 200A and the 5G base station 200B are not distinguished from each other.

The UE 100 is a mobile communication apparatus. The UE 100 may be any type of apparatus as long as the apparatus is a communication apparatus used by a user. Examples of the UE 100 include a mobile phone terminal (including a smartphone), a tablet terminal, a notebook PC, a communication module (including a communication card or a chipset), a sensor or an apparatus provided on a sensor, and/or a vehicle or an apparatus provided on a vehicle (Vehicle UE).

The base station 200 is an apparatus performing wireless communication with the UE 100. The base station 200 manages one or a plurality of cells. The “cell” is used as a term representing a minimum unit of a wireless communication area. The “cell” is also used as a term representing a function or a resource for performing wireless communication with the UE 100. One cell belongs to one carrier frequency.

The 4G base station 200A performs, with the UE 100, wireless communication conforming to Long Term Evolution (LTE) being a wireless communication scheme of 4G. In the NSA configuration, the 4G base station 200A performs control of wireless communication (hereinafter referred to as “communication control”) performed by the UE 100. The 4G base station 200A manages a cell 10A. Note that the 4G base station 200A is also referred to as an eNodeB.

The 5G base station 200B performs, with the UE 100, wireless communication conforming to New Radio (NR) being a wireless communication scheme of 5G. In the NSA configuration, the 4G base station 200A performs data communication with the UE 100. The 5G base station 200B manages a cell 10B. A carrier frequency of the cell 10B is higher than a carrier frequency of the cell 10A. A coverage area of the cell 10B is narrower than a coverage area of the cell 10A, and is located within the coverage area of the cell 10A. Note that the 5G base station 200B is also referred to as a gNodeB.

Each of the 4G base station 200A and the 5G base station 200B is connected to the core network 20. The core network 20 manages an area in which the UE 100 exists, and performs transfer control of data of the UE 100. In an embodiment, the core network 20 is a core network of 4G. The core network of 4G is also referred to as Evolved Packet Core (EPC). The core network 20 may be a core network of 5G. The core network of 5G is also referred to as a 5G core network (5GC).

The 4G base station 200A and the 5G base station 200B are connected to each other via an inter-base station interface 30, and perform inter-base station communication via the inter-base station interface 30. The 4G base station 200A and the 5G base station 200B may perform inter-base station communication via the core network 20, not via the inter-base station interface 30.

In the mobile communication system 1 configured as described above, the UE 100 is located in the cell 10B of the 5G base station 200B. The UE 100 first connects to the 4G base station 200A, subsequently connects to the 5G base station 200B as well in accordance with a connection instruction from the 4G base station 200A, and thereby performs high speed data communication with the 5G base station 200B.

Configuration of User Equipment

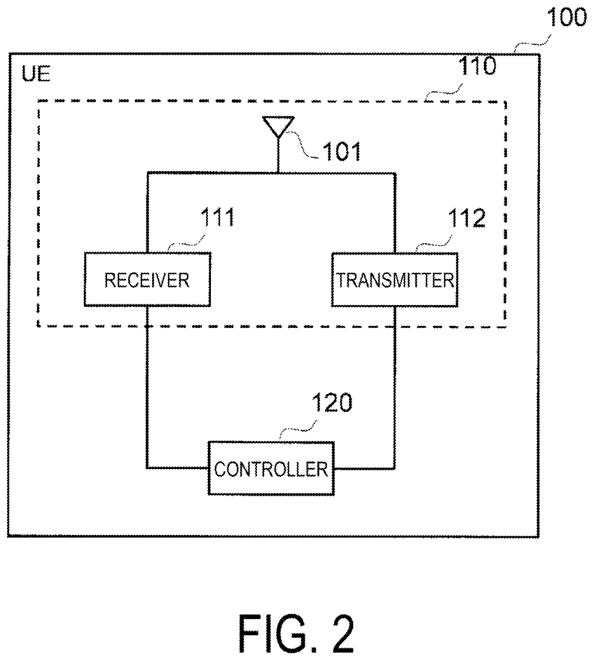

A configuration of the UE 100 (user equipment) according to an embodiment will be described. FIG. 2 is a diagram illustrating a configuration of the UE 100. As illustrated in FIG. 2, the UE 100 includes a wireless communicator 110 and a controller 120.

The wireless communicator 110 performs wireless communication with the base station 200. The wireless communicator 110 includes an antenna 101, a receiver 111, and a transmitter 112. The receiver 111 performs various types of reception under control of the controller 120. The receiver 111 converts a radio signal received by the antenna 101 into a baseband signal (reception signal) and outputs the baseband signal to the controller 120. The transmitter 112 performs various types of transmission under control of the controller 120. The transmitter 112 converts a baseband signal (transmission signal) output by the controller 120 into a radio signal and transmits the radio signal from the antenna 101.

The wireless communicator 110 supports both of LTE being a wireless communication scheme of 4G and NR being a wireless communication scheme of 5G. The wireless communicator 110 can perform NR communication with the 5G base station 200B while performing LTE communication with the 4G base station 200A.

The controller 120 performs various types of control in the UE 100. Specifically, the controller 120 controls the wireless communicator 110. The controller 120 includes at least one processor and at least one memory electrically connected to the processor. The memory stores a program to be executed by the processor and information to be used for processing by the processor. The processor may include a baseband processor and a central processing unit (CPU). The baseband processor performs modulation and demodulation, coding and decoding, and the like of a baseband signal. The CPU executes the program stored in the memory to thereby perform various types of processing.

Configuration of Base Station

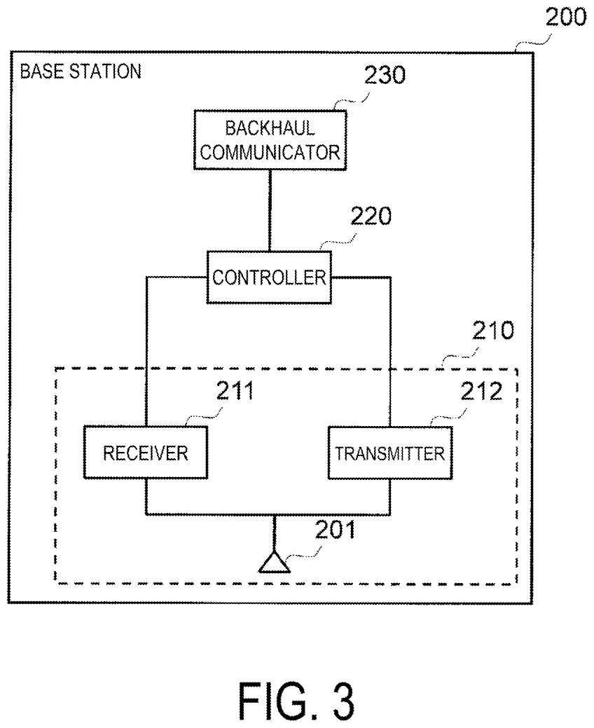

A configuration of the base station 200 according to an embodiment will be described. FIG. 3 is a diagram illustrating a configuration of the base station 200. As illustrated in FIG. 3, the base station 200 includes a wireless communicator 210, a controller 220, and a backhaul communicator 230.

The wireless communicator 210 performs wireless communication with the UE 100. The wireless communicator 210 includes an antenna 201, a receiver 211, and a transmitter 212. The receiver 211 performs various types of reception under control of the controller 220. The receiver 211 converts a radio signal received by the antenna 201 into a baseband signal (reception signal) and outputs the baseband signal to the controller 220. The transmitter 212 performs various types of transmission under control of the controller 220. The transmitter 212 converts a baseband signal (transmission signal) output by the controller 220 into a radio signal and transmits the radio signal from the antenna 201.

When the base station 200 is the 4G base station 200A, the wireless communicator 210 supports LTE being a wireless communication scheme of 4G. In contrast, when the base station 200 is the 5G base station 200B, the wireless communicator 210 supports NR being a wireless communication scheme of 5G.

The controller 220 performs various types of control in the base station 200. Specifically, the controller 220 controls the wireless communicator 210 and the backhaul communicator 230. The controller 220 includes at least one processor and at least one memory electrically connected to the processor. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 230 is connected to a neighboring base station via the inter-base station interface. The backhaul communicator 230 is connected to the core network 20, and is also connected to the neighboring base station via the inter-base station interface 30.

Configuration of Protocol Stack

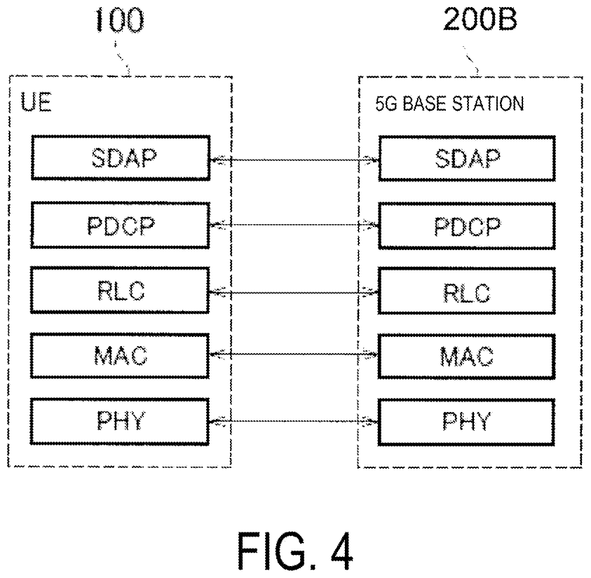

A configuration of a protocol stack according to an embodiment will be described. FIG. 4 is a diagram illustrating a configuration of a protocol stack of a radio interface of a user plane handling data. In the NSA configuration, the UE 100 performs data communication being communication of the user plane with at least the 5G base station 200B.

As illustrated in FIG. 4, radio interface protocols of the user plane include a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Between the PHY layer of the UE 100 and the PHY layer of the 5G base station 200B, data and control information are transmitted via a physical channel.

The MAC layer performs preferential control of data, retransmission processing using a hybrid ARQ (HARQ), a random access procedure, and the like. Between the MAC layer of the UE 100 and the MAC layer of the 5G base station 200B, data and control information are transmitted via a transport channel. The MAC layer of the 5G base station 200B includes a scheduler. The scheduler determines transport formats (transport block sizes, modulation and coding schemes (MCSs)) in the uplink and the downlink and resource blocks to be allocated to the UE 100.

The RLC layer transmits data to the RLC layer at the reception end by using functions of the MAC layer and the PHY layer. Between the RLC layer of the UE 100 and the RLC layer of the 5G base station 200B, data and control information are transmitted via a logical channel.

The PDCP layer performs header compression and decompression, and encryption and decryption.

The SDAP layer performs mapping between an IP flow being a unit for a core network to perform QoS control and a radio bearer being a unit for an Access Stratum (AS) to perform QoS control. Note that, when the 5G base station 200B is connected to the EPC, the SDAP layer may be absent.

Note that the UE 100 includes an application layer, in addition to the protocols of the radio interface.

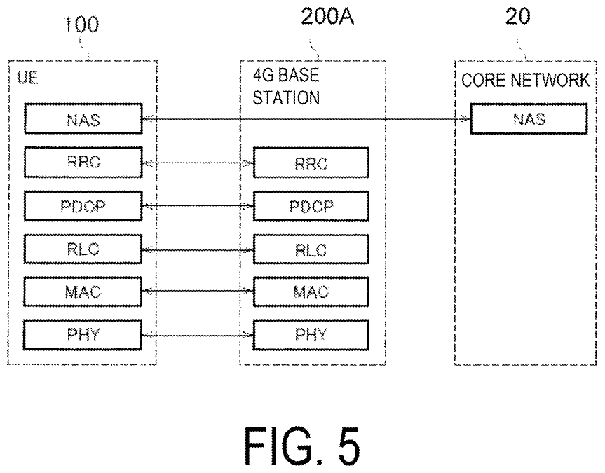

FIG. 5 is a diagram illustrating a configuration of a protocol stack of a radio interface of a control plane handling signaling (control signal). In the NSA configuration, the UE 100 performs communication of the control plane with at least the 4G base station 200A.

As illustrated in FIG. 5, the protocol stack of the radio interface of the control plane includes a Radio Resource Control (RRC) layer and a Non-Access Stratum (NAS) layer instead of the SDAP layer illustrated in FIG. 4.

Between the RRC layer of the UE 100 and the RRC layer of the 4G base station 200A, RRC signaling for various configurations is transmitted. The RRC layer controls a logical channel, a transport channel, and a physical channel according to establishment, reestablishment, and release of a radio bearer. When connection (RRC connection) is established between the RRC of the UE 100 and the RRC of the 4G base station 200A, the UE 100 is in an RRC connected state. When no connection (RRC connection) is established between the RRC of the UE 100 and the RRC of the 4G base station 200A, the UE 100 is in an RRC idle state.

The NAS layer located in a layer higher than the RRC layer performs session management, mobility management, and the like. Between the NAS layer of the UE 100 and the NAS layer of the core network 20, NAS signaling is transmitted.

Connection Processing

Connection processing according to an embodiment will be described. The connection processing is processing for the UE 100 to connect to the base station 200. Such connection processing is referred to as a random access procedure in the standard of 3GPP. The random access procedure has two types, namely a “contention based” random access procedure and a “non-contention based” random access procedure.

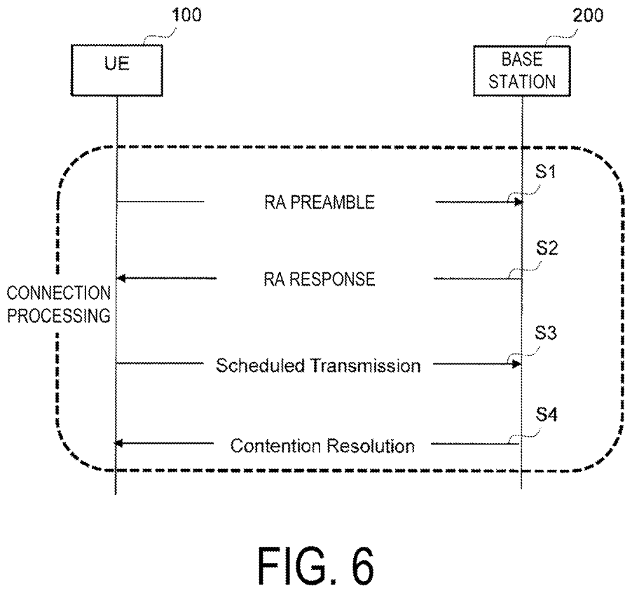

FIG. 6 is a diagram illustrating the contention based random access procedure. The contention based random access procedure is used when the non-contention based random access procedure is not available, and includes the following four steps.

As illustrated in FIG. 6, in Step S1, the controller 120 of the UE 100 selects any one random access preamble out of a random access preamble (preamble sequence) group available for contention based random access, and transmits the selected random access preamble from the wireless communicator 110. System information broadcast by the base station 200 includes information of the random access preamble available for the contention based random access. The wireless communicator 110 of the UE 100 transmits the selected random access preamble (RA preamble) to the base station 200 on a Random Access Channel (RACH). Note that the random access preamble does not include an identifier of the UE 100 (UE identifier).

In Step S2, when the wireless communicator 110 of the base station 200 receives the random access preamble, the controller 220 of the base station 200 transmits the random access response (RA response) from the wireless communicator 210 to the UE 100. Here, the controller 220 of the base station 200 estimates an uplink delay with the UE 100, based on the random access preamble received from the UE 100. The controller 220 of the base station 200 determines radio resources to be allocated to the UE 100. The random access response includes a timing correction value based on results of delay estimation, information of the determined radio resources to be allocated, and an identifier (preamble identifier) for identifying the random access preamble received from the UE 100.

In Step S3, when the wireless communicator 110 of the UE 100 receives the random access response, the controller 120 of the UE 100 transmits a connection request message from the wireless communicator 110 to the base station 200. The connection request message is a message transmitted and received in the RRC layer, and is also referred to as a message 3 (Msg3) or Scheduled Transmission. The connection request message includes a UE identifier. For example, the UE identifier is a Temporary Mobile Subscriber Identity (TMSI).

In Step S4, when the controller 220 of the base station 200 receives the connection request message, a contention resolution message (Contention Resolution) is transmitted from the wireless communicator 210 to the UE 100. The contention resolution message is a message transmitted and received in the RRC layer, and is also referred to as a message 4 (Msg4). The contention resolution message includes the UE identifier included in the connection request message received by the base station 200. For example, the contention resolution message includes the connection request message itself as a contention resolution ID. The controller 120 of the UE 100 receives the contention resolution message including the connection request message (contention resolution ID) transmitted by the controller 120 itself, and thus determines that the random access procedure has been completed.

In the contention based random access procedure as described above, a plurality of pieces of UE 100 may simultaneously transmit the same random access preamble (same preamble sequence) to the base station 200. Such contention is also referred to as preamble contention (or preamble collision).

Such a plurality of pieces of UE 100 involved in preamble contention each transmit a connection request message to the base station 200, in response to one random access response transmitted from the base station 200. The base station 200 includes, in the contention resolution message, a UE identifier included in the first received connection request message, for example. As a result, the UE 100 having first transmitted the connection request message out of the plurality of pieces of UE 100 involved in the preamble contention is connected to the base station 200.

The UE 100 not specified in the contention resolution message, that is, the UE 100 failing to normally receive the contention resolution message, resumes the random access procedure from Step S1 after the elapse of a predetermined period of time (back-off time). Accordingly, the contention based random access procedure may require a long time (that is, connection processing delay) before the UE 100 is connected to the base station 200.

In contrast, in the non-contention based random access procedure, the base station 200 specifies the random access preamble for the UE 100 in advance. The random access preamble is uniquely allocated to the UE 100, and contention with other UE 100 does not occur, and thus Steps S3 and S4 described above are unnecessary. In the non-contention based random access procedure, a connection processing delay due to preamble contention does not occur.

Connection Control to 5G Base Station in NSA Configuration Connection control to the 5G base station 200B in the NSA configuration according to an embodiment will be described. In the NSA configuration, the UE 100 first connects to the 4G base station 200A, subsequently connects to the 5G base station 200B as well in accordance with a connection instruction (hereinafter referred to as a “5G base station connection instruction”) from the 4G base station 200A, and thereby performs high speed data communication with the 5G base station.

The UE 100 has no option but to use the contention based random access procedure at the time of connection to the 4G base station 200A; however, at the time of the subsequent connection to the 5G base station 200B, the UE 100 can use not only the contention based random access procedure but also the non-contention based random access procedure.

In other words, methods of acquiring the random access preamble to be used when the UE 100 connects to the 5G base station 200B include a first method (contention based random access procedure) in which the UE 100 acquires the random access preamble from system information broadcast by the 5G base station 200B and a second method (non-contention based random access procedure) in which the 4G base station 200A provides, to the UE 100, the random access preamble acquired by the 4G base station 200A from the 5G base station 200B.

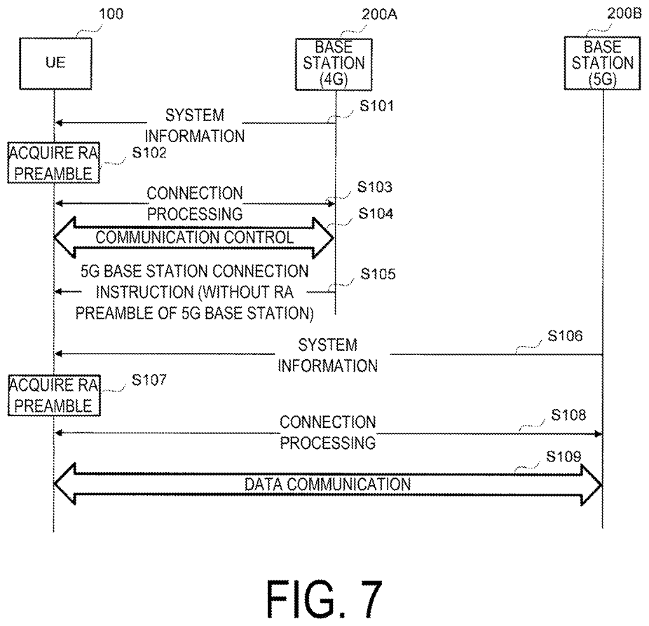

FIG. 7 is a diagram illustrating the first method of connection control to the 5G base station 200B in the NSA configuration.

As illustrated in FIG. 7, in Step S101, the wireless communicator 210 of the 4G base station 200A broadcasts system information. The system information includes information of the random access preamble available for contention based random access to the 4G base station 200A. Here, the UE 100 is in the RRC idle state. The wireless communicator 110 of the UE 100 receives the system information broadcast from the 4G base station 200A.

In Step S102, the controller 120 of the UE 100 acquires the random access preamble, based on the system information received from the 4G base station 200A.

In Step S103, the UE 100 and the 4G base station 200A perform the connection processing described above (see FIG. 6), specifically, the contention based random access procedure. With this, the UE 100 connects to the 4G base station 200A, and the UE 100 transitions from the RRC idle state to the RRC connected state.

In Step S104, the controller 220 of the 4G base station 200A performs communication control for the UE 100. For example, the controller 220 of the 4G base station 200A controls the wireless communicator 210 to instruct the UE 100 to measure a radio state relating to a neighboring base station. The controller 120 of the UE 100 measures the radio state, and controls the wireless communicator 110 to transmit a measurement report indicating the measurement results to the 4G base station 200A. Based on the measurement report from the UE 100, the controller 220 of the 4G base station 200A determines that the UE 100 is present within the coverage area of the cell 10B of the 5G base station 200B, and determines to cause the UE 100 to connect to the 5G base station 200B.

In Step S105, the controller 220 of the 4G base station 200A controls the wireless communicator 210 to transmit, to the UE 100, a 5G base station connection instruction for instructing connection to the 5G base station 200B. The 5G base station connection instruction is an instruction for causing the UE 100 to connect to the 5G base station 200B while maintaining connection between the UE 100 and the 4G base station 200A. The 5G base station connection instruction may be a message transmitted and received in the RRC layer.

In the first method of connection control, the 5G base station connection instruction does not include the random access preamble used for the non-contention based random access procedure (that is, the random access preamble uniquely allocated to the UE 100 by the 5G base station 200B). In response to reception of such a 5G base station connection instruction, the controller 120 of the UE 100 determines that the contention based random access procedure needs to be performed for the 5G base station 200B.

In Step S106, the wireless communicator 210 of the 5G base station 200B broadcasts system information. The system information includes information of the random access preamble available for contention based random access to the 5G base station 200B. The wireless communicator 110 of the UE 100 receives the system information broadcast from the 5G base station 200B.

In Step S107, the controller 120 of the UE 100 acquires the random access preamble, based on the system information received from the 5G base station 200B.

In Step S108, the UE 100 and the 5G base station 200B perform the connection processing described above (see FIG. 6), specifically, the contention based random access procedure. With this, the UE 100 also connects to the 5G base station 200B.

In Step S109, the UE 100 and the 5G base station 200B perform data communication.

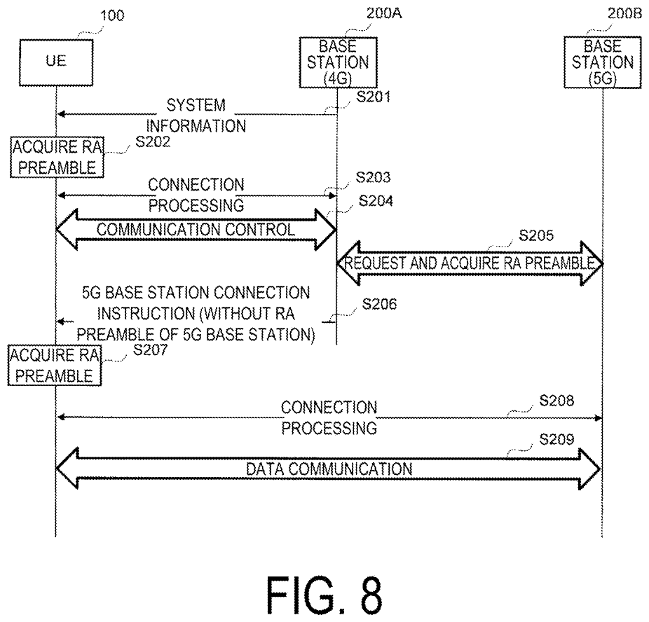

FIG. 8 is a diagram illustrating the second method of connection control to the 5G base station 200B in the NSA configuration.

As illustrated in FIG. 8, operations of Steps S201 to S204 are the same as and/or similar to those of the first method of connection control described above.

Note that, in Step S204, the controller 220 of the 4G base station 200A determines to cause the UE 100 to connect to the 5G base station 200B, and determines to include, in the 5G base station connection instruction, the random access preamble acquired by the 4G base station 200A from the 5G base station 200B.

In Step S205, the controller 220 of the 4G base station 200A controls the backhaul communicator 230 to request the random access preamble to be uniquely allocated to the UE 100 from the 5G base station 200B. Here, the backhaul communicator 230 of the 4G base station 200A requests the random access preamble from the 5G base station 200B through inter-base station communication with the 5G base station 200B. The controller 220 of the 5G base station 200B allocates the random access preamble to the UE 100 in response to the request from the 4G base station 200A, and controls the backhaul communicator 230 to notify the 4G base station 200A of the allocated random access preamble. The controller 220 of the 4G base station 200A acquires the random access preamble from the 5G base station 200B.

In Step S206, the controller 220 of the 4G base station 200A controls the wireless communicator 210 to transmit, to the UE 100, a 5G base station connection instruction for instructing connection to the 5G base station 200B.

In the second method of connection control, the 5G base station connection instruction includes the random access preamble to be used for the non-contention based random access procedure (that is, the random access preamble uniquely allocated to the UE 100 by the 5G base station 200B). Upon reception of such a 5G base station connection instruction, the controller 120 of the UE 100 determines to perform the non-contention based random access procedure for the 5G base station 200B.

In Step S207, the controller 120 of the UE 100 acquires the random access preamble included in the 5G base station connection instruction received from the 4G base station 200A.

In Step S208, the UE 100 and the 5G base station 200B perform the non-contention based random access procedure. In the non-contention based random access procedure, the UE 100 transmits the random access preamble acquired from the 4G base station 200A to the 5G base station 200B. With this, the UE 100 also connects to the 5G base station 200B.

In Step S209, the UE 100 and the 5G base station 200B perform data communication.

Here, through a comparison between the first method (FIG. 7) and the second method (FIG. 8) of connection control, it can be said that the second method does not cause preamble contention and is thus more reliable than the first method. However, the second method requires a step (Step S205) in which the 4G base station 200A acquires the random access preamble from the 5G base station 200B, and thus causes a delay for the step. On the other hand, the first method does not cause a delay due to the 4G base station 200A acquiring the random access preamble from the 5G base station 200B, but may cause a connection delay if preamble contention occurs.

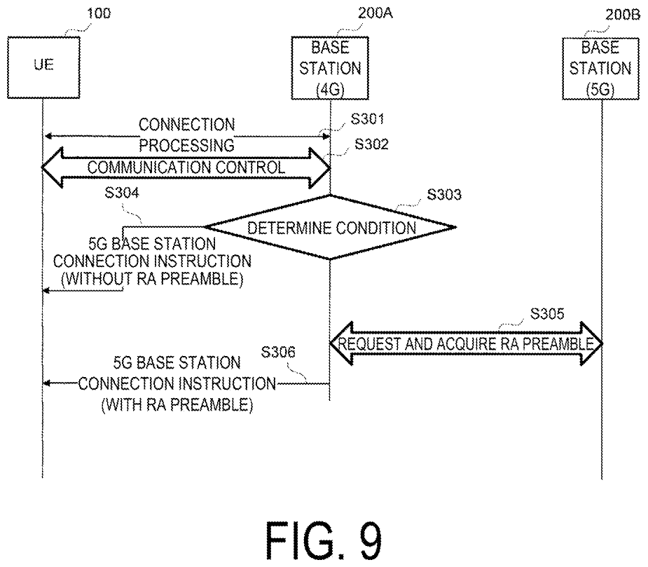

In an embodiment, the 4G base station 200A properly uses the first method or the second method of connection control depending on each situation, and therefore enables smooth connection processing between the UE 100 and the 5G base station 200B. FIG. 9 is a diagram illustrating an operation for properly using a corresponding method of connection control to the 5G base station 200B in the NSA configuration depending on each situation.

As illustrated in FIG. 9, in Step S301, the UE 100 and the 4G base station 200A perform the connection processing described above (see FIG. 6), specifically, the contention based random access procedure. With this, the UE 100 connects to the 4G base station 200A, and the UE 100 transitions from the RRC idle state to the RRC connected state.

In Step S302, the controller 220 of the 4G base station 200A performs communication control for the UE 100.

In Step S303, the controller 220 of the 4G base station 200A determines whether to include, in the 5G base station connection instruction, the random access preamble acquired by the 4G base station 200A from the 5G base station 200B, based on a congestion level of the 5G base station 200B.

For example, the controller 220 of the 4G base station 200A controls the backhaul communicator 230 to acquire the congestion level of the 5G base station 200B. The backhaul communicator 230 of the 4G base station 200A acquires the congestion level of the 5G base station 200B through inter-base station communication with the 5G base station 200B. The congestion level of the 5G base station 200B may be any indicator as long as the indicator indicates a degree of congestion of the 5G base station 200B. The congestion level of the 5G base station 200B is, for example, at least one selected from the group consisting of the number of pieces of UE connected to the 5G base station 200B, a use rate of radio resources of the 5G base station 200B, and a use rate of hardware (for example, the CPU) of the 5G base station 200B.

The controller 220 of the 4G base station 200A may acquire the congestion level of the 5G base station 200B by estimating the congestion level of the 5G base station 200B, based on a congestion level of the 4G base station 200A. Specifically, because the cell 10A of the 4G base station 200A and the cell 10B of the 5G base station 200B partially overlap, the congestion level of the 5G base station 200B may be considered to be substantially equal to the congestion level of the 4G base station 200A.

When the congestion level of the 5G base station 200B is higher than a predetermined level, the controller 220 of the 4G base station 200A selects the second method described above (that is, the non-contention based random access procedure). Specifically, the controller 220 of the 4G base station 200A controls the backhaul communicator 230 to acquire the random access preamble from the 5G base station 200B (Step S305), and controls the wireless communicator 210 to transmit, to the UE 100, a 5G base station connection instruction including the acquired random access preamble(Step S306).

When the 5G base station 200B is congested, preamble contention is more likely to occur in the contention based random access procedure. Thus, when the 5G base station 200B is congested, the controller 220 of the 4G base station 200A selects the second method (non-contention based random access procedure) and thus the UE 100 can smoothly connect to the 5G base station 200B.

In contrast, when the congestion level of the 5G base station 200B is equal to or lower than the predetermined level, the controller 220 of the 4G base station 200A selects the first method described above (contention based random access procedure). Specifically, the controller 220 of the 4G base station 200A controls the wireless communicator 210 to transmit, to the UE 100, a 5G base station connection instruction not including the random access preamble (Step S304).

When the 5G base station 200B is not congested, preamble contention is less likely to occur in the contention based random access procedure. Thus, when the 5G base station 200B is not congested, the controller 220 of the 4G base station 200A selects the first method (contention based random access procedure) and thus the UE 100 can smoothly connect to the 5G base station 200B.

In Step S303, the controller 220 of the 4G base station 200A may determine whether to include, in the 5G base station connection instruction, the random access preamble acquired by the 4G base station 200A from the 5G base station 200B, based on a service type used by the UE 100.

For example, when the service type used by the UE 100 is a delay-tolerable service, the controller 220 of the 4G base station 200A selects the second method described above (non-contention based random access procedure). Specifically, the controller 220 of the 4G base station 200A controls the backhaul communicator 230 to acquire the random access preamble from the 5G base station 200B (Step S305), and controls the wireless communicator 210 to transmit, to the UE 100, a 5G base station connection instruction including the acquired random access preamble (Step S306).

Note that the delay-tolerable service refers to a service other than real-time services (for example, a voice call and a streaming distribution). Examples of the delay-tolerable service include an IoT service such as periodic uploading of sensor measurement data, and file transfer using the File Transfer Protocol (FTP). The controller 220 of the 4G base station 200A may determine the service type used by the UE 100, based on a QoS Class Identifier (QCI) allocated to the bearer of the UE 100.

When the service type used by the UE 100 is the delay-tolerable service and the congestion level of the 5G base station 200B is higher than the predetermined level, the controller 220 of the 4G base station 200A may select the second method described above (non-contention based random access procedure).

In contrast, when the service type used by the UE 100 is not the delay-tolerable service (for example, when the service type used by the UE 100 is a real-time service), the controller 220 of the 4G base station 200A may select the first method described above (contention based random access procedure). Specifically, the controller 220 of the 4G base station 200A controls the wireless communicator 210 to transmit, to the UE 100, a 5G base station connection instruction not including the random access preamble (Step S304).

When the service type used by the UE 100 is not the delay-tolerable service and the congestion level of the 5G base station 200B is equal to or lower than the predetermined level, the controller 220 of the 4G base station 200A may select the first method described above (contention based random access procedure).

In this manner, the controller 220 of the 4G base station 200A determines whether to include, in the 5G base station connection instruction, the random access preamble acquired by the 4G base station 200A from the 5G base station 200B, based on at least one selected from the group consisting of the congestion level of the 5G base station 200B and the service type used by the UE 100. In other words, the controller 220 of the 4G base station 200A selects the contention based random access procedure or the non-contention based random access procedure as the random access procedure from the UE 100 to the 5G base station 200B, based on at least one selected from the group consisting of the congestion level of the 5G base station 200B and the service type used by the UE 100. With this, the UE 100 can smoothly connect to the 5G base station 200B.

### OTHER EMBODIMENTS

In the embodiment described above, the NSA configuration for operating the 5G system using the network infrastructure of the 4G system has been described. In the NSA configuration, the UE 100 connects to the 4G base station 200A and also connects to the 5G base station 200B. However, instead of such an NSA configuration, a configuration of dual connection in the same system may be employed.

For example, the UE 100 connects to a first 4G base station (master base station) and also connects to a second 4G base station (secondary base station). In such a configuration of dual connection, the 4G base station 200A in the embodiment described above is read as the first 4G base station, and the 5G base station 200B in the embodiment described above is read as the second 4G base station.

The UE 100 connects to a first 5G base station (master base station) and also connects to a second 5G base station (secondary base station). In such a configuration of dual connection, the 4G base station 200A in the embodiment described above is read as the first 5G base station, and the 5G base station 200B in the embodiment described above is read as the second 5G base station.

The operations according to the embodiment described above may be applied to handover of the UE 100 between the base stations. For example, the UE 100 performs handover from the 4G base station 200A to the 5G base station 200B in accordance with a connection instruction (handover instruction) from the 4G base station 200A. The UE 100 may perform handover from the first 4G base station to the second 4G base station, or may perform handover from the first 5G base station to the second 5G base station.

A program causing a computer to execute each of the processing operations performed by the UE 100 or the base station 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and examples of which may include a recording medium such as a CD-ROM or a DVD-ROM. Circuits for executing the processing operations performed by the UE 100 or the base station 200 may be integrated, and at least a part of the UE 100 or the base station 200 may be configured as a semiconductor integrated circuit (a chipset or an SoC).

Although the embodiment has been described in detail with reference to the drawings, a specific configuration is not limited to those described above, and various design modifications and the like can be made without departing from the gist.

1. A base station used in a mobile communication system, the base station comprising:
a wireless communicator configured to perform wireless communication with user equipment; and
a controller configured to control the wireless communicator, wherein
the wireless communicator is configured to transmit, to the user equipment, a connection instruction of causing the user equipment to connect to another base station, and
the controller is configured to determine whether to include, in the connection instruction, a random access preamble acquired by the base station from the other base station, based on at least one selected from the group consisting of a congestion level of the other base station and a service type used by the user equipment.

2. The base station according to claim 1, wherein
the connection instruction is an instruction of causing the user equipment to connect to the other base station while maintaining connection between the user equipment and the base station.

3. The base station according to claim 2, wherein
a wireless communication scheme to which the base station conforms is different from a wireless communication scheme to which the other base station conforms.

4. The base station according to claim 1, wherein
the controller is configured to control the wireless communicator to transmit, to the user equipment, the connection instruction including the random access preamble, according to a fact that the congestion level of the other base station is higher than a predetermined level.

5. The base station according to claim 4, wherein
the controller is configured to control the wireless communicator to transmit, to the user equipment, the connection instruction not including the random access preamble, according to a fact that the congestion level of the other base station is equal to or lower than the predetermined level.

6. The base station according to claim 1, wherein
the controller is configured to control the wireless communicator to transmit, to the user equipment, the connection instruction including the random access preamble, according to a fact that the service type used by the user equipment is a delay-tolerable service.

7. The base station according to claim 6, wherein
the controller is configured to control the wireless communicator to transmit, to the user equipment, the connection instruction not including the random access preamble, according to a fact that the service type used by the user equipment is not the delay-tolerable service.

8. A control method of a base station performing communication with another base station and performing communication with user equipment in a mobile communication system, the control method comprising:
determining whether to include a random access preamble acquired by a base station from another base station in a connection instruction of causing user equipment to connect to the other base station; and
transmitting the connection instruction to the user equipment, wherein
the determining comprises the determining based on at least one selected from the group consisting of a congestion level of the other base station and a service type used by the user equipment.

9. A mobile communication system comprising:
user equipment; and
a base station configured to perform communication with another base station and perform communication with the user equipment, wherein
the base station is configured to include a random access preamble acquired from the other base station in a connection instruction of causing the user equipment to connect to the other base station, using at least one selected from the group consisting of a congestion level of the other base station and a service type used by the user equipment, when the base station transmits the connection instruction to the user equipment.
